(19) United States
(12) Patent Application Publication
(10) Pub. No.: US 2004/0193855 A1
(43) Pub. Date: Sep. 30, 2004

(54) System and method for branch prediction access

(76) Inventors: Nicolas Kacevas, Sunnyvale, CA (US); Eran Altshuler, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/401,962

(22) Filed: Mar. 31, 2003

(51) Int. Cl. G06F 9/44

(52) U.S. Cl. 712/237; 712/240

(57) ABSTRACT

A processor including a branch prediction unit, wherein various techniques can be used to decrease branch prediction unit access, possibly saving power. Whether or not a branch prediction target needs updating may be stored, and thus it may be known whether or not the branch prediction unit needs to be accessed after the initial access. Which way corresponds to the prediction may be stored, decreasing the amount of subsequent accesses. Use information (e.g., least recently used information) may be updated at the time of the first access of the branch prediction unit, possibly eliminating the need for a later use information update. A branch prediction unit update or allocate, or update or allocate attempt, may be performed prior to the execute stage.

### FIELD OF THE INVENTION

Embodiments of the invention relate to a system and method for use in a processor; more specifically to a system and method for the use and operation of a branch prediction unit.

### BACKGROUND OF THE INVENTION

Modern microprocessors implement a variety of techniques to increase the performance of instruction execution, including superscalar microarchitecture, pipelining, out-of-order, and speculative execution.

A processor may include branch prediction techniques. For example, branch target buffers (BTBS) store information about branches that have been previously encountered. Typically, a memory such as an associative memory is provided. An associatively addressed tag array holds the address (or closely related address) of recent branch instructions. The data fields associated with each tag entry may include, for example, information on the target address, the history of the branch (e.g., taken/not taken), use information (e.g., least recently used information) and branch target instruction information.

Typically, the fetch addresses used by the processor are coupled to the branch address tags. If a hit occurs, the instruction at the fetch address causing the hit is presumed to be a previously encountered branch. The history information is accessed and a prediction on the branch may be made. Other branch prediction techniques and BTB structures may be used.

In modern processors, BTBs are increasingly large and power hungry. Each BTB read consumes power, which is a valuable resource in modern computer systems.

Furthermore, current branch prediction methods may not efficiently or quickly correct wrong information in BTBs.

### BRIEF DESCRIPTION OF THE DRAWINGS

Embodiments of the invention will be understood and appreciated more fully from the following detailed description taken in conjunction with the drawings in which:

FIG. 1 is a simplified block-diagram illustration of a system and a processor according to one embodiment of the invention;

FIG. 2 depicts the BTB of FIG. 1, according to an embodiment of the invention;

FIG. 3 depicts a series of operations according to an embodiment of the invention; and

FIG. 4 depicts a series of operations according to an embodiment of the invention.

### DETAILED DESCRIPTION OF THE INVENTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well known features may be omitted or simplified in order not to obscure embodiments of the invention described herein.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computer or other apparatus. Embodiments of the invention described herein are not described with reference to any particular programming language, machine code, etc. It will be appreciated that a variety of programming languages, machine codes, etc may be used to implement the teachings of the embodiments of the invention described herein.

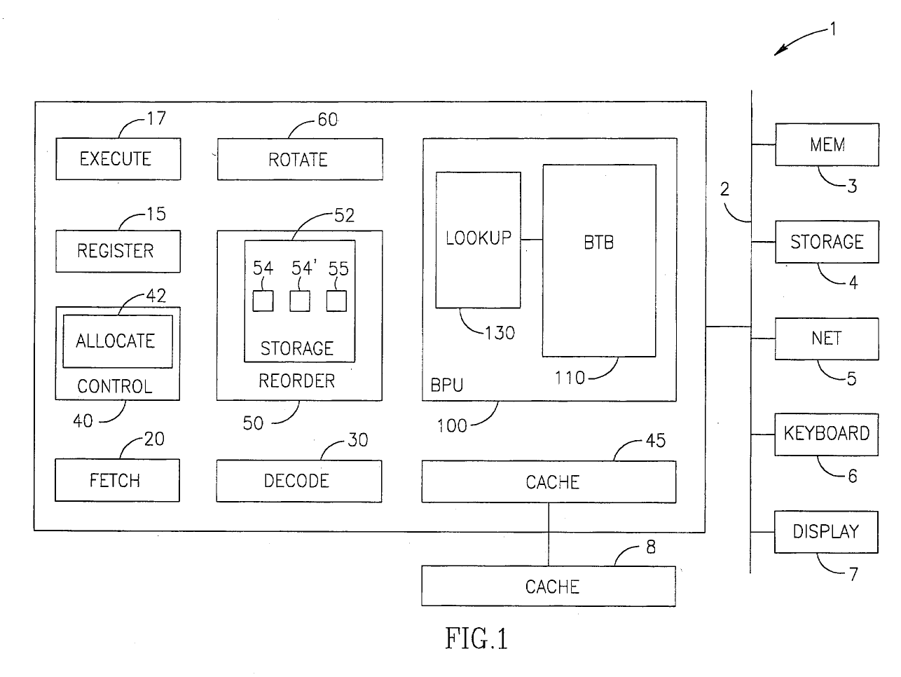

FIG. 1 is a simplified block-diagram illustration of a system and a processor according to one embodiment of the invention. A wide issue, superscalar, pipelined microprocessor is shown, although the scope of the invention is not limited in this respect. Other processor types may be used. For example, a data processor used with an embodiment of the invention may use a RISC (Reduced Instruction Set Computer) architecture, may use a Harvard architecture, may be a vector processor, may be a single-instruction-multiple-data (SIMD) processor, may perform floating point arithmetic, may perform digital signal processing computations, etc. Except for improvements over the prior art related to embodiments of the invention, the example shown comprises components, a structure, and functionality similar to an Intel® Pentium™ Processor. However, this is an example only and is not intended to limit the scope of the invention. Embodiments of the invention may be used within or may include processors having varying structures and functionality. Note that not all connections and components within the processor or outside of the processor are shown, for clarity, and known components and features may be omitted, for clarity.

Referring to FIG. 1, system 1 includes processor 10. Processor 10 includes at least one execution unit 17 (of course, multiple execution units can be used). Processor 10 may include a branch prediction unit (BPU) 100, including a branch target buffer (BTB) 110, and a lookup unit 130. Processor 10 may include an internal cache 45 and/or may be connected to an external cache 8. Alone or in combination, the caches 45 and 8 may form a multi-layered cache system. For example, an L0 cache, L1 cache, etc, may be part of one or more of caches 45 and 8. Each of caches 45 and 8 may include one or be implemented as more caches.

Processor 10 may include, for example, one or more register file(s) 15, which may be register files of known construction, one or more fetch units 20, one or more decode units 30, a control unit 40, and a reorder buffer 50. Control unit 40 may include allocate logic 42, for determining if an allocate to the BTB 110 is needed. Processor 10 may include instruction predecoder units, such as buffers (not shown), a rotator 60, or other units. Processor 10 may include other components and other combinations of components. Furthermore, the functionality need not be divided as shown. For example, allocate logic 42 need not be included with or associated with control unit 40.

System 1 may include, inter alia, one or more bus(es) 2, one or more memory(ies) 3 (e.g., a RAM, ROM, or other components, or a combination of such components), one or more mass storage device(s) 4 (e.g., a hard disk, or other components, or a combination of such components), a network connection 5, a keyboard 6, and a display 7. The memory 3 is typically external to or separate from the processor 10. However, the memory 3, or other components, may be located, for example, on the same chip as the processor 10. Other components or sets of components may be included. System 1 may be, for example, a personal computer or workstation. Alternately, the system may be constructed differently, and the processor need not be included within a computer system as shown, or within a computer system. For example, the processor may be included within a “computer on a chip” system, or the system holding the processor may be, for example, a controller for an appliance such as an audio or video system.

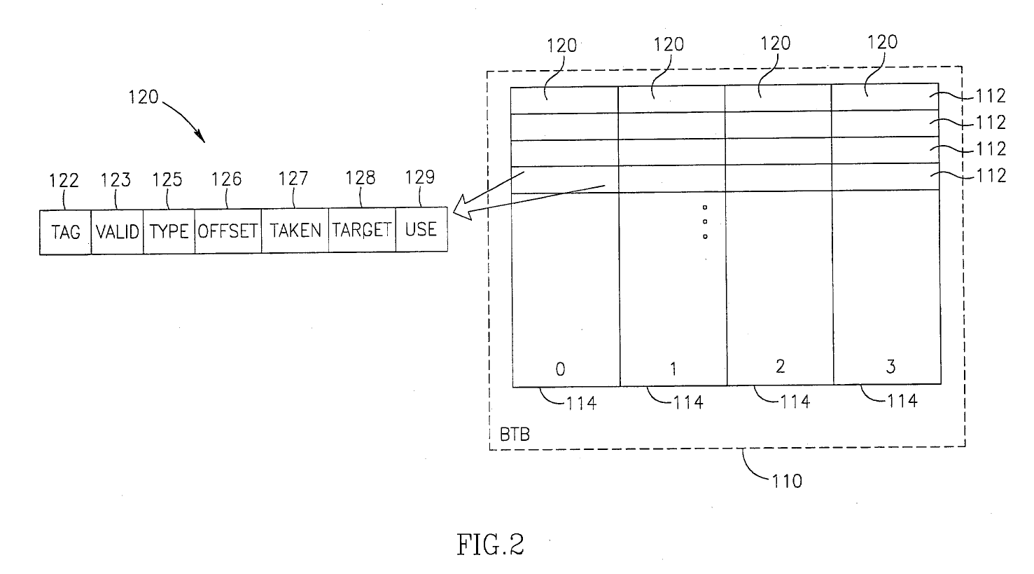

FIG. 2 depicts the BTB of FIG. 1, according to an embodiment of the invention. Referring to FIG. 2, the BTB 110 may include, for example, a number of lines 112. Each line 112 may include a number of entries 120. Typically, the lines 112 are divided according to a number of ways 114 (e.g., ways 114 0-3, although other numbers of ways or divisions may be used); typically one entry 120 exists per way 114. Typically, each entry 120 includes information such as a tag 122, validity information 123, a branch type 125, an offset 126, history or taken/not taken information 127, a predicted branch target 128, and use information 129. Taken/not taken or history information 127 may include, for example, N-bits of state (N is typically 2), which allows an N-bit counter to be set up for each branch tracked. Typically, use information 129 includes least recently used (LRU) information, but may include other information and be in other formats. For example, use information 129 may include a set of LRU bits (e.g., two bits) representing a four state counter. Other information may be included, and the information may be stored in various known formats. When used herein, a set may include one unit.

Reorder buffer 50 (FIG. 1) may, for example, keep track of the original program sequence, implement register renaming, allow for speculative instruction execution and branch misprediction recovery, to facilitate precise exceptions, etc. One or more temporary storage locations 52 within reorder buffer 50 may, for example, store speculative register states, branch prediction information 54, fix/not fix information 54′ (described below), way information 55 (described below), instruction operands or results, information on whether or not an allocate or update had been performed, etc. Upon decode of a particular instruction, information on the instruction may be routed to reorder buffer 50 and/or other units. In alternate embodiments, a reorder buffer 50 need not be used, and branch prediction information may be stored in a different location outside the BTB 110.

Prediction information may be attached to, stored with, or otherwise associated with an instruction as it passes through the processor; this is done separate from or outside the BTB 110 or other branch prediction structure. Doing so separately from the branch prediction mechanism may obviate the need for extra reads or accesses to such a mechanism.

Information on which of multiple ways 114 in a line 112 may correspond to an instruction's BTB 110 entry may be stored as way information 55. Way information 55 may be stored with or associated with an instruction as the instruction travels through the pipeline. If it is necessary to update the BTB 110, the way information 55 may be used to determine which way 114 should be accessed. This may, for example, eliminate the need for determining which way 114 should be accessed by, for example, reading tags, and may decrease power usage. Way information 55, may be, for example, a set of 2 bits in a four way system, but may include other information in other forms. When used herein, a set may include one element.

Fix/not fix information 54′ may include, for example, the result of a comparison of actual branch target information to branch target information taken from the BTB 110.

Reorder buffer 50 may be used to store, outside of the BTB 110, one or more of way information 55, fix/not fix information 54′ and/or branch prediction information 54 for an instruction during processing of the instruction. One or more temporary storage locations 52 within reorder buffer 50 may be provided for such storage. In another embodiment, way information 55, fix/not fix information 54′ and/or branch prediction information 54 is attached to an instruction as it goes through the pipeline, for example in an instruction packet, or a data structure associated with an instruction, with information that may be added to the instruction as it passes through the pipeline. Way information 55, fix/not fix information 54′ and/or branch prediction information 54 may be stored, for example, in the rotator 60.

In alternative embodiments, way information 55, fix/not fix information 54′ and/or branch prediction information 54 may be attached to, stored with or associated with an instruction in other manners, in other structures.

An instruction may be stored and manipulated in the processor as is known in the art.

In a typical current system, a BTB read takes place after branch information is resolved; typically at or after the execution stage. Such a read is typically required for each branch instruction, regardless of the correctness of the prediction, so that the information for the instruction in the BTB can be compared (e.g., in a compare circuit) to the actual instruction information and possibly to update the use (e.g., LRU) information. For example, the actual target information are compared to the predicted information. If the predicted and actual information differ, a BTB allocate or read is typically required.

When an instruction is being fetched (or alternately at another time), the BPU 100 is queried with the instruction address. The BPU 100 performs a lookup in the BTB 110 to determine if this instruction is in the BTB 110. If there is a BTB 110 hit, the entry 120 or information from the entry 120, corresponding to the instruction, is read out.

At the time the BTB 110 is first accessed for an instruction in a cycle, the use information 129 (e.g., LRU information) for that instruction may be updated. This may be done before the decode stage, and typically at the time the BTB 110 is initially accessed for a particular instruction. Typically, such an update is performed using use information which is read from the BTB 110—e.g., updating the state defined by a set of bits—but need not be. Use information 129 may be altered by a suitable algorithm (e.g., an LRU replacement algorithm or other algorithm) before being written back to the BTB 110.

If it is later determined that the BTB 110 does not need to be accessed for a second or additional time for this instruction for, for example, the purpose of a BTB 110 update or allocation, that the use information 129 has been updated allows for less BTB 110 access. Lowering BTB 110 access may aid in, for example, power savings. Further, updating use information at a time when the way holding the particular entry is known may aid in reducing power consumption, as multiple ways need not be read to determine which entry needs updating.

In the decode stage fix/not fix information 54′ or other information may be created based on branch prediction information 54, and may be used to augment branch prediction information 54 or may be stored with or associated with an instruction instead of branch prediction information 54. Typically, fix/not fix information 54′ indicates whether or not the decode stage determined that the target as predicted by the branch prediction information 54 is correct, and/or whether or not the decode stage corrected the branch prediction information 54. Fix/not fix information 54′ may be, for example, one or more bits. At the decode stage, for some branches, the branch target (and possibly, but not necessarily, taken/not taken information) may be known. If the branch target is known and correctly matches information in branch prediction information 54, fix/not fix information 54′ may be set to “not fix”, indicating that the prediction information does not need correction. Further, a “not fix” setting may be created if, for whatever reason, the decode stage did not or could not determine that the branch target or other information was correct or incorrect. Otherwise, fix/not fix information 54′ may be set to “fix”, indicating that the prediction information does need correction, or was corrected by the decode stage. Such settings may be represented by, for example, one or more bits. In other embodiments, further differentiation may be added to fix/not fix information 54′, such as a signal or information differentiating between a fix not occurring because the information is correct and a fix not occurring because a stage was unable to determine the correct information.

In one embodiment, fix/not fix information 54′ does not include information related to taken/not taken information, but in other embodiments, fix/not fix information 54′ may include such information or other information.

Typically, after fix/not fix information 54′ is determined, either branch prediction information 54 or corrected branch prediction information is stored outside of BTB 110 associated with an instruction, and not both; however, in alternative embodiments, branch prediction information 54 is kept through the pipeline process regardless of the existence of corrected information. If branch prediction information 54 is determined to be correct it need not be “replaced” or corrected. Fix/not fix information 54′ may be used later in the pipeline stage to determine if a BTB 110 update is needed.

In alternative embodiments, fix/not fix information 54′ may be determined by units or circuits other than a decode unit. For example, if a decode stage cannot conclusively determine if a prediction is correct, such information may be determined by a later stage; alternately, a decode stage may not set such information at all. Further, fix/not fix information 54′ may not be needed, and branch prediction information 54 may be kept throughout the passage of the instruction through the pipeline, and may be used later in the pipeline stage to determine if a BTB 110 update is needed.

After the decoder or another unit corrects branch target information (if such a correction takes place), the corrected target may be stored. As an instruction passes through the pipeline of the processor, a branch target is stored or associated with the instruction. This branch target may be a predicted branch target—for example, a target retrieved from BTB 110. This branch target may also be a true branch target, derived from the instruction itself as the instruction is processed. In either case, the target is associated with the instruction, possibly in known manners. The target may be stored as discussed above, for example in reorder buffer 50, or in another structure.

Associating prediction information for an instruction and/or fix/not fix information 54′ with the instruction or otherwise storing such information outside the BTB 110 may permit an additional read, typically performed at the end of processing in current systems to determine in BTB information needs updating, to be omitted, possibly saving power.

Prediction information from the entry 120, or fix/not fix information 54′, may be attached to or otherwise associated with an instruction as it passes through the processor. During or after the execution stage, if fix/not fix information 54′ indicates that the decode stage (or another stage) corrected the branch prediction information or determined that the prediction information was wrong, a BTB 110 update is performed.

In other embodiments, other information, such as branch prediction information 54, may be used to determine if an update is needed after execution. Further, such a BTB update may be performed at other times, and need not be performed after execution.

Since, in such a case, it can be determined, without accessing the BTB 110, if an update or allocation is needed, if an update or allocation is not needed, the BTB 110 is not accessed, possibly saving power.

Branch information relating to the instruction may be of other types. Typically, such information is known at or after execution of an instruction, but all or parts of such information may be known at other times—for example, the decode stage may provide information on whether or not an instruction is a branch, the type of branch, and possibly the target.

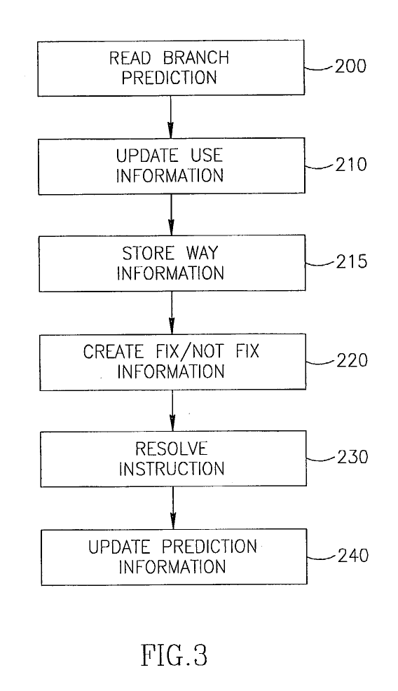

FIG. 3 depicts a series of operations according to an embodiment of the invention. Referring to FIG. 3, in operation 200, a branch prediction mechanism (e.g., BPU 100) is read for branch prediction information. As is known, not every instruction is a branch, and not every instruction may be stored in or predicted by a branch prediction mechanism. Thus a given instruction may produce a “miss” for the branch prediction mechanism.

In operation 210, use information in the branch prediction mechanism (e.g., use information 129) may be updated.

In operation 215, information on which of multiple ways in a line corresponds to the instruction's BTB entry may be stored.

In operation 220, the instruction passes through the decode stage, branch prediction information may be augmented with or replaced by, for example, fix/not fix information.

In operation 230, the instruction is resolved. Typically, after the instruction is processed in the execute stage, it is known whether or not the branch prediction information is correct.

In operation 240, if needed, the branch prediction mechanism is updated with the correct branch information. Previously stored way information may be used to determine which way is to be updated. If not needed, such an update need not be performed. Typically, such a decision is based on fix/not fix information. For example, fix/not fix information may include information as to whether a previous stage, such as the decode stage, determined that the branch prediction read from the BTB 110 needs updating. If the branch prediction information read from the BTB 110 in operation 200 was incorrect, the BTB 110 can be updated. Considerations other than whether or not a branch existing in a BTB was wrongly predicted may be used in deciding whether or not to allocate an instruction.

In other embodiments, other operations or series of operations may be used. Furthermore, various aspects depicted in the flowchart may be used independently. For example, way information need not be stored or used, and LRU updates need not be performed as shown.

In, one embodiment of the invention, if needed, an allocate or update (or an attempt to allocate or update) to a BTB 110 may be performed after the decode operation, or even after or during the operation of correcting branch prediction information. In such a case, if fix/not fix information 54′ has been set to “fix”, it may, after such a successful allocate, be set to “not fix”, indicating to downstream processes that a further allocate need not be performed for this instruction. In the case that an allocate is attempted during or after the decode stage, but is not successful, for example due to a BTB 110 collision, the fix/not fix information 54′ may remain as or be set to “fix”. In alternate embodiments, other indicators may be used to record whether a successful allocate or update has been performed. Such indicators may be stored, for example, in temporary storage locations 52 within reorder buffer 50, or may be stored in other locations.

The update or allocate attempt need not be performed during or after the decode, but may be performed after the update or allocate information is known, and typically before the execute stage. For example, if it is determined an update is needed, an update or allocate attempt may be performed. If an update or allocate attempt cannot be performed, due to, for example, a collision with another update or attempt, the update or allocate or a re-attempt at an update or allocate may be performed later. Such update or allocate attempts may be performed repeatedly until a successful update or allocate is performed for this instruction.

Collision detection capability may be used in BPU 100 to help ensure that multiple writes do not conflict with each other or, for example, with a BTB 110 read. Known collision detection methods may be used. Between two allocates or updates, priority may be given to an allocate or update for the instruction that entered the pipeline earlier. An alternate expression of this scheme is that an allocate or update request from a later stage (e.g., execute) takes priority over that from an earlier stage (e.g. decode). Further, between an allocate or update and a BTB 110 read, priority may be given to the allocate or update. However, other priority schemes may be used.

Such an early allocate may be done, for example, for reasons of speed or performance or prediction accuracy, or for other reasons.

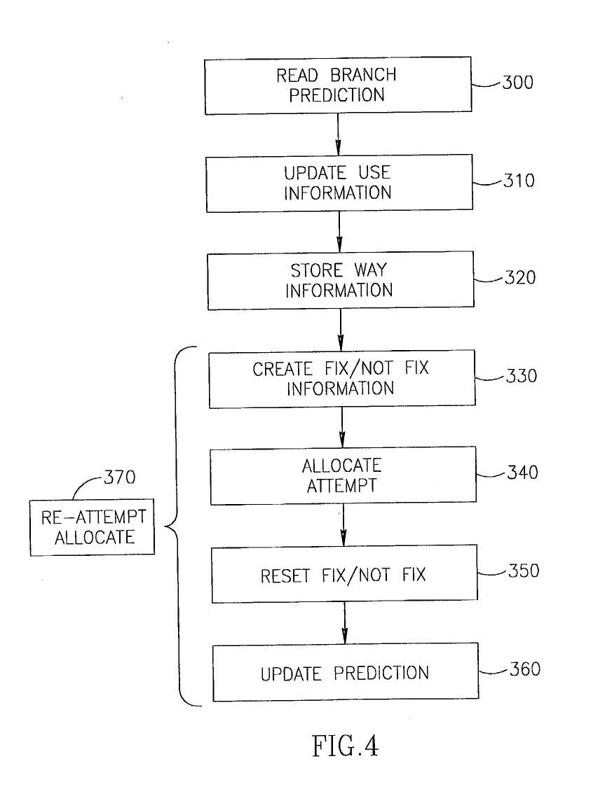

FIG. 4 depicts a series of operations according to an embodiment of the invention. Such operations may be performed by various circuits in a processor; for example BPU 100, a decode unit 30, a control unit 40, etc. Referring to FIG. 4, in operation 300, a branch prediction mechanism (e.g., BPU 100) is read for branch prediction information.

In operation 310, use information in the branch prediction mechanism (e.g., use information 129) may be updated.

In operation 320, information on which of multiple ways in a line corresponds to the instruction's BTB entry may be stored.

In operation 330, the instruction passes through the decode stage, and branch prediction information may be augmented with or replaced by, for example, fix/not fix information. Fix/not fix information may be created by, for example, a comparison of actual and predicted branch information. An erroneous item in predicted branch information may indicate that fix/not fix information should be set to fix, and/or that an allocate or update to a BTB is to be performed.

In operation 340, if needed, an attempt to update or allocate the branch prediction mechanism may be performed, to correct branch information. This may be done during or after the decode stage. In a further embodiment this may be done before the instruction is processed in the execute stage. A condition such as a collision may prevent an allocate at this point. As discussed above, stored way information may be used.

In operation 350, if a successful update or allocate occurred in operation 340, fix/not fix information may be reset to indicate that no allocate or update needs to be performed, as an allocate was performed. For example, setting fix/not fix information to indicate no that no fix was done (and thus no update or allocate is required) may have such an effect, although other methods of indicating to a later stage that an allocate does not be performed may be used, and other data structures may be used.

In operation 360, the instruction is processed in the execute stage.

In operation 370, at any point, if needed and if appropriate, an attempt to update or allocate the branch prediction mechanism may be performed, if such an attempt was unsuccessful previously. Typically, if fix/not fix information indicates “no fix” or “do not allocate” or a similar signal, or if other information indicates that an allocate does not need to be performed, an attempt to allocate or update is not performed.

In other embodiments, other operations or series of operations may be used. Furthermore, various aspects depicted in the flowchart may be used independently. For example, an allocate or update may be performed before an execute stage without the use of fix/not fix information.

While a particular structure and mechanism is shown for predicting branches—a BPU with an associated BTB—other mechanisms for predicting branches may be used.

Typically, the various functionality described herein, such as comparing a branch prediction to an actual branch target, storing information such as way information or the results of a compare of branch targets, updating a BPU based on such information, or updating LRU information, may be performed by circuits in various parts of the processor, as shown, or by other known units. For example, various operations shown may be performed by BPU 100, a decode unit of decode units 30, a control unit 40, etc. Different functionality may be performed by different parts of the processor.

It will be appreciated by persons skilled in the art that embodiments of the invention are not limited by what has been particularly shown and described hereinabove. Rather the scope of at least one embodiment of the invention is defined by the claims that follow:

What is claimed is:

1. A method comprising:
reading an entry in a branch table buffer, the entry corresponding to an instruction; and
updating a least recently used field corresponding to the entry at the time of or before the time of the decoding of the instruction.

2. The method of claim 1, wherein the least recently used field includes at least a set of bits.

3. The method of claim 1, wherein the execution is performed in a pipelined processor.

4. A method comprising:
reading an entry in a branch table buffer, the entry corresponding to an instruction being processed by a processor, the entry including a predicted branch target address; and
storing the predicted branch target address outside the branch table buffer in a manner associated with the instruction.

5. The method of claim 4 comprising:
comparing an actual branch target address to the predicted branch target address; and
storing the result of the comparison.

6. The method of claim 5, comprising, based on the result of the comparison, allocating the instruction in the branch table buffer.

7. The method of claim 5, comprising storing the comparison with the instruction.

8. A method comprising:
reading an entry in a branch table buffer, the entry corresponding to an instruction being processed by a processor, the entry including a predicted target address;
determining an actual target branch address of the instruction;
comparing the predicted target address to the actual target branch address; and
storing the results of the comparison.

9. The method of claim 8, comprising, based on the result of the comparison, allocating the instruction in the branch table buffer.

10. The method of claim 8, comprising storing the comparison with the instruction.

11. The method of claim 8, comprising associating the comparison with the instruction.

12. The method of claim 8, wherein the comparison occurs before an execution stage.

13. The method of claim 8, wherein the results of the comparison include a bit.

14. A method comprising:
reading an entry in a branch table buffer, the entry corresponding to an instruction, the entry being stored in a way; and
storing information on in which way the entry is stored.

15. The method of claim 14, wherein the information on in which way the entry is stored is stored such that it is associated with the instruction.

16. The method of claim 14, wherein the information on in which way the entry is stored is stored with the instruction.

17. The method of claim 14, comprising updating the branch table buffer based on the information on in which way the entry is stored.

18. A processor comprising:
a branch table buffer containing entries corresponding to instructions, each entry including a least recently used field; and
a circuit to, when an instruction is being processed, update a least recently used field corresponding to the entry corresponding to that instruction at the time of or before the time of the decoding of the instruction.

19. The processor of claim 18, wherein the least recently used field includes at least a set of bits.

20. A processor comprising:
a branch table buffer containing a set of entries, each entry corresponding to an instruction and including a predicted target address; and
a circuit to determine an actual target branch address of the instruction, compare the predicted target address to the actual target branch address, and store the results of the comparison.

21. The processor of claim 20 wherein the circuit is to, based on the result of the comparison, allocate the instruction in the branch table buffer.

22. The processor of claim 20 wherein the circuit is to store the comparison with the instruction.

23. The processor of claim 20 wherein the circuit is to associate the comparison with the instruction.

24. The processor of claim 20 wherein the comparison occurs before an execution stage.

25. A processor comprising:
a branch table buffer containing a set of ways, wherein the processor is to, during the processing of an instruction:
read an entry in the branch table buffer, the entry corresponding to an instruction, the entry being stored in a way; and
store information on in which way the entry is stored.

26. The processor of claim 25, wherein the information on in which way the entry is stored is stored such that it is associated with the instruction.

27. The processor of claim 25, wherein the processor is to update the branch table buffer based on the information on in which way the entry is stored.

28. A computer system comprising:
a memory; and
a processor, wherein the processor is capable of performing the method of claim 1.

29. The computer system of claim 28, wherein the memory is separate from the processor.

30. A processor comprising:
a branch table buffer including a set of entries, an entry corresponding to an instruction being processed by the processor;
a circuit to read an entry from the branch prediction unit, and if the entry is erroneous, to attempt to update the branch prediction unit; and
wherein the processor is to, at a point in time after the update attempt, process the instruction in an execute stage.

31. The processor of claim 30, wherein if a collision occurs during the attempt to update, the update is re-attempted at a later point.

32. The processor of claim 30, wherein the circuit is to attempt to update the branch prediction unit after processing the instruction in a decode stage.

33. The processor of claim 30, wherein the circuit is to compare the entry to an actual target branch address and store the results of the comparison.

34. The processor of claim 33, wherein the circuit is to, if a successful update is performed, set the results of the comparison to indicate that no update needs to be performed.

35. The processor of claim 33, wherein the comparison occurs before an execution stage.

36. The processor of claim 33, wherein the results of the comparison include a bit.

37. A method comprising:
reading an entry in a branch prediction unit, the entry corresponding to an instruction being processed by a processor;
if the entry is erroneous, attempting to update the branch prediction unit; and
at a point in time after the update attempt, processing the instruction in an execute stage.

38. The method of claim 37, wherein if a collision occurs during the attempt to update, the update is re-attempted at a later point.

39. The method of claim 37, comprising attempting to update the branch prediction unit after processing the instruction in a decode stage.

40. The method of claim 37 comprising:
comparing the entry to an actual target branch address; and
storing the results of the comparison.

41. The method of claim 40, wherein if a successful update is performed, the results of the comparison are set to indicate that no update needs to be performed.

42. The method of claim 40, wherein the comparison occurs before an execution stage.

43. The method of claim 40, wherein the results of the comparison include a bit.

44. A computer system comprising:
a memory; and
a processor, wherein the processor is capable of performing the method of claim 8.

45. The computer system of claim 44, wherein the memory is separate from the processor.

46. A computer system comprising:
a memory; and
a processor, wherein the processor is capable of performing the method of claim 37.

47. The method of claim 46, wherein if a successful update is performed, an indicator is set to indicate that no update needs to be performed.
